(19) United States
(12) Patent Application Publication
(10) Pub. No.: US 2007/0119149 A1
(43) Pub. Date: May 31, 2007

(54) Hyperjet

(76) Inventor: Leonard Marandiuc, Arlington, VA (US)

Correspondence Address: Raymond M. Galasso;Galasso & Associates LP, P.O. Box 26503, Austin, TX, 78755-0503, US

(21) Appl. No.: 11/290,330

(22) Filed: Nov. 30, 2005

(51) Int. Cl. F02K 7/10

(52) U.S. Cl. 60/224; 60/767

(57) ABSTRACT

The present invention provides a hypersonic jet engine able to start in air-breathing mode, on its own, from zero speed without a compressor. The hypersonic jet engine, known herein as the hyperjet is also able to fly an aircraft at and faster than Mach 6 without using the scramjet method of combustion, while maintaining a fuel economy superior to that of a aircraft utilizing a turbofan engine. The present invention is operable in a pulsejet mode, a ramjet mode, and chemical rocket mode, and utilizes front and back airflow gates driven by DC motors or electromagnetic fields.

### FIELD OF THE INVENTION

The present invention relates to jet engines, and more specifically but not by way of limitation, to a hypersonic jet engine operable in a pulsejet mode, a ramjet mode, and a chemical rocket mode, in part, by utilizing front and rear air flow gates.

### BACKGROUND

In the aircraft industry, there is always a desire to improve an aircnifts ability to fly faster, farther and with more fuel efficiency, per passenger. As such, there is a desire in the industry to be able to have supersonic and hypersonic flights, with aircraft that have fuel consumption better than turbofan-propelled jumbo-jet aircraft (whose size is similar to that of a Boeing™ 747).

The desire and need for improved speed, range and fuel efficiency is not limited to the aircraft industry. As can be appreciated, it also extends into the spacecraft industry.

Accordingly there is a need for an aircraft engine capable of moving large aircraft at hypersonic speeds while having fuel consumption much lower than that of a turbofan-propelled aircraft of similar size.

### SUMMARY OF THE INVENTION

The present invention provides a hypersonic jet engine able to start in air-breathing mode, on its own, from zero speed without a compressor. The hypersonic jet engine is further able to fly an aircraft at and faster than Mach 6 without using the scramjet method of combustion, while maintaining a fuel economy equal to or better that that of a turbofan engine. The present invention is operable in a pulsejet mode, a ramjet mode, and chemical rocket mode, and utilizes front and back airflow gates driven by DC motors or electromagnetic fields to regulate the intake and exhaust of the engine.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 illustrates a perspective view of an engine mounted to a wing of an aircraft in accordance with the principles of the present invention;

FIGS. 2-5 illustrate cross-sectional views of a preferred embodiment of the present invention in various operating modes taken along line A-A of FIG. 1;

FIG. 6 illustrates a partial cross-sectional side view of the interior of the engine at the combustor ring;

FIG. 7 illustrates a front view of a preferred embodiment of the present invention; and

FIG.8 illustrates a cross-sectional side view of a preferred embodiment of a ramjet combustor.

### DETAILED DESCRIPTION

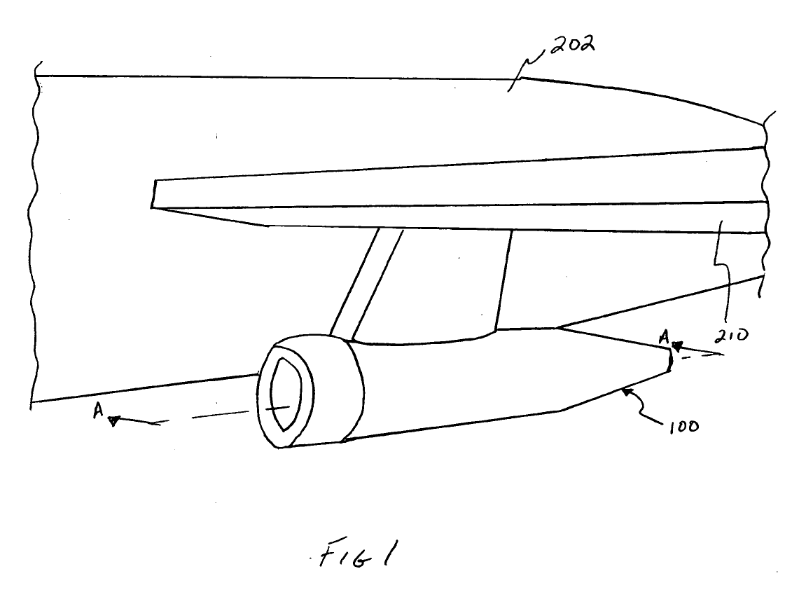

Referring now to the drawings submitted herewith, wherein various elements depicted are not necessarily drawn to scale, and where like elements in various views are depicted with identical element numbers, and in particular to FIG. 1, there is illustrated a perspective view of a preferred embodiment of a hyperjet 100 in accordance with the principles of the present invention. Hyperjet 100 is illustrated attached to the underside of wing 210 of an aircraft 202.

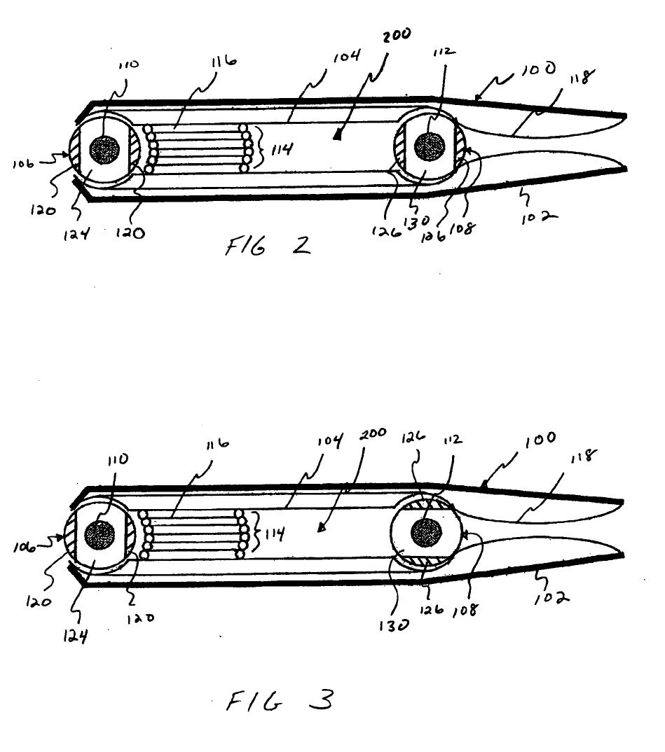

Referring now to FIGS. 2-5, there is illustrated a side cross-sectional view taken along line A-A of FIG. 1, illustrating the interior components of hyperjet 100. As described in more detail herein, hyperjet 100 is operable in various modes, including a pulsejet mode, a ramjet mode, and chemical rocket mode.

As illustrated, hypedjet 100 includes an exterior casing 102 for housing the components therein. Disposed within exterior casing 102 is an interior casing and fuel injector housing 104. Airflow gate assemblies 106 and 108 are also disposed within exterior casing 102, with airflow gate assembly 106 being positioned at the intake end of hyperjet 100 and airflow gate assembly 108 being positioned at the exhaust end of hyperjet 100. Airflow gate assemblies 106 and 108 are hollow spheres containing a pipe as wide as the interior diameter of the hypedjet 100. DC motors 110 and 112 are connected to airflow gates assemblies 106 and 108 respectively. A ramjet combustor ring 114 is positioned proximate to airflow gate assembly 106, with ramjet combustor ring 114 made up of a plurality of ramjet burners 116.

Airflow gate assembly 106 includes gate 120 and a flow path 124, and airflow gate assembly 108 includes gate 126 and flow path 130.

In pulsejet mode, airflow gate assemblies 106 and 108 facilitate complete combustion within hyperjet 100, with airflow gate assemblies 106 and 108 being open and closed by DC motors 110 and 112. Airflow gate assemblies 106 and 108 are configured in a piped sphere configuration, which does not produce unnecessary shape changes in movement. This helps to facilitate supersonic flight as a result of the drag/shockwave reduction due to the shapes of the airflow gate assemblies 106 and 108. It is comtemplated that the airflow gate assemblies 106 and 108 could be either pilot or computer controlled. This allows for a more accurate account for ambient air pressure and temperature changes during flight. Upon being exhausted from airflow gate 108 through supersonic nozzle 118, the combusted gas pressure is to be as close as possible to ambient air pressure. This facilitates the avoidance of shockwave formation at the rear of hyperjet 100 at supersonic speeds.

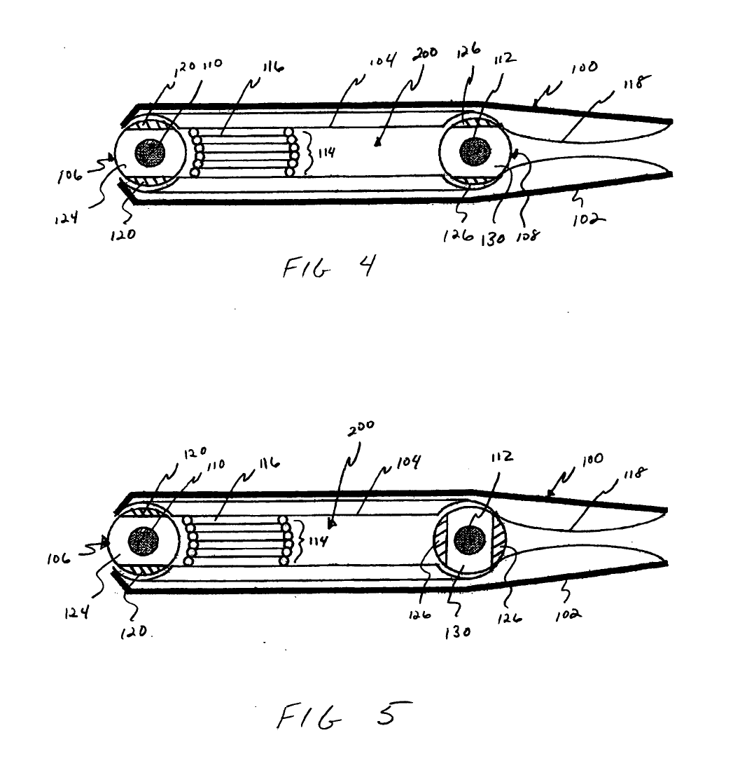

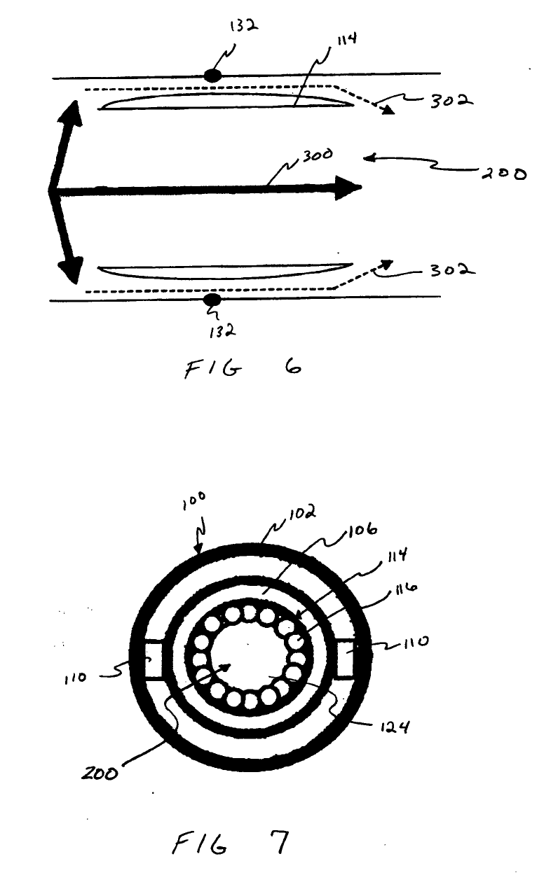

Referring now to FIG. 6, there is illustrated a partial cross-sectional side view of the interior of hypejet 100 behind airflow gate 106 showing airflow through and about hyperjet 100 at combustor ring 114. As illustrated, a portion of airflow 300 enters the main burner 200 of hyperjet 100, while another portion 302 of air flow 300 enter the ramjet burners of ramjet combustor ring 114. Fuel Injectors 132 inject and mix fuel with airflow 302 in each of the ramjet burners 116 (see FIG. 7) of ramjet combustor ring 114. Airflows 302 and 300 then flow towards the exhaust of hyperjet 100.

Referring now to FIG. 7, there is illustrated a frontal view of hyperjet 100 with airflow gate 106 in the open position such that flow path 124 permits airflow into hyperjet 100. As illustrated, when airflow gate 106 is in the open position, airflow is permitted to enter both the ramjet combustor ring 114 and the center or main burner portion 200 of hyperjet 100. DC motor 110 is configured within hyperjet 100 to operate the opening and closing of airflow gate 106. Similarly, DC motor 112 is configured within hyperjet 100 to operate the opening and closing of airflow gate 108.

Referring now to FIGS. 6 and 7, combustor ring 114 is comprised of a collective of ramjet burners or combustors 116. Ramjet combustors 116 function only when hyperjet 100 is operating in ramjet mode. When operating in ramjet mode, hyperjet 100 has a performance increase similar to the performance increase offered by the turbofan over the turbojet. In this preferred embodiment, the number of ramjet combustors 116 is always an even number; with the ramjet combustors 116 functioning in symmetrically oriented pairs in order to keep the overall airflow direction parallel to the direction of hyperjet 100.

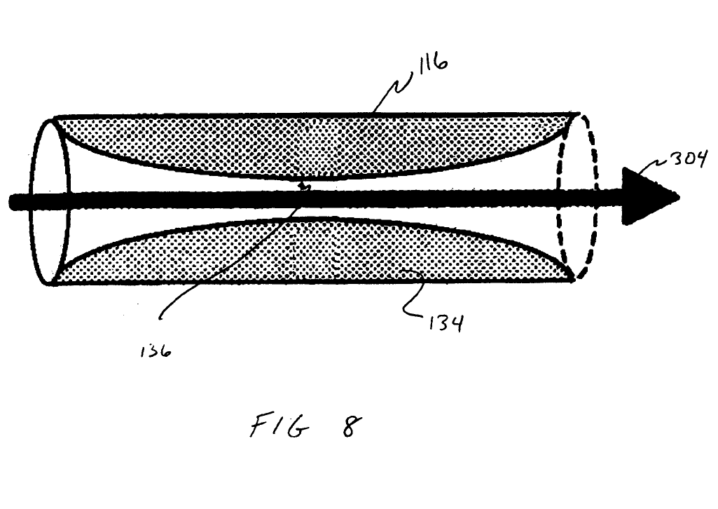

Referring now to FIG. 8, there is illustrated a sectional side view of a ramjet burner 116 of ramjet combustor ring 114. As illustrated, casing 134 generally tapers from each end of ramjet burner 116 towards the center of ramjet burner 116, forming a throat portion 136. It is at the throat portion 136 where the fuel injection and combustion take place in ramjet burner 116. Arrow 304 illustrates typical airflow through ramjet burner 116 during operation.

As mentioned herein, hyperjet 100 is operable in various modes, including a pulsejet mode, a ramjet mode, and chemical rocket mode. Referring now to FIGS. 1-8, a more detailed description of each of these modes will now be described.

When operating in pulsejet mode, first airflow gates 106 and 108 are both closed (See FIG. 2), whereby air is enclosed in the main burner portion 200 of hypedjet 100. Fuel is then injected and detonated in the main burner portion 200 of hypedjet 100, creating the pulse. The main burner portion 200 of hypersonic engine 100 acts as a close-volume pressure vessel. Then gate 108 open, while gate 106 remains closed (See FIG. 3). As a result of the detonation of the fuel injected into the main burner portion 200 of hypersonic engine 100 and the pressure created therein, the high-temperature and high-pressure is then exhausted from hyperjet 100 through supersonic nozzle, creating thrust.

With airflow gate 108 remaining open, airflow gate 106 then opens (See FIG. 4), permitting the influx of air into hyperjet 100 through airflow gate 106.

Airflow gate 108, then closes (See FIG. 5), whereby the main burner portion 200 of hypersonic engine 100 becomes filled with air at the maximum possible pressure (i.e. stagnation). Once filled with air, the cycle repeats.

Good results have been achieved with the operation of hyperjet 100 in pulsejet mode when both airflow gates 106 and 108 spin at a steady or constant speed.

When hypedjet 100 is operating in ramjet mode, both airflow gates 106 and 108 are maintained in the open position, such as is illustrated in FIG. 4. In ramjet mode, combustion of fuel is carried out in the ramjet burners 116 of ramjet combustor ring 114 (see FIG. 8) instead of in the main burner 200 of hyperjet 100. At supersonic speeds, incoming air is slowed into ramjet burners 116 to Mach 1 and gains pressure and temperature in the process. The incoming air reacts with the fuel at Mach 1, is combusted and then exhausted into the main burner area 200 at the same speed as the incoming air (See FIG. 6). This keeps very high pressure and temperature differences from the incoming air. Good results have been achieved by maintaining straight orientation of the exhaust gas by using ram et burners 116 in pairs opposite each other. The incoming air 300 becomes mixed with the high pressure-and-temperature gas 302 and then becomes exhausted such that the exhaust pressure matches the ambient air pressure at an exhaust speed/temperature combination which creates the desired sufficient thrust. In this embodiment, only 20% of the incoming air is burned, which accomplishes about 80% fuel savings over existing ramjets.

When hyperjet 100 is operating in chemical rocket mode, airflow gate 106 is maintained in the closed position, while airflow gate 108 is maintained in the open position (See FIG. 3). In chemical rocket mode, an independent air/oxygen supply is required as airflow gate 108 is in the closed position, inhibiting air intake into jet engine 100. In this embodiment, hyperjet 100 can be switched to chemical rocket mode at any speed. Hyperjet 100 can be switched from rocket mode to pulsejet mode if the speed is below Mach 1.85. Hyperjet 100 can be switched to ramjet mode if the speed is above Mach 2. Hyperjet 100 can be switched from chemical rocket mode to either ramjet mode or pulsejet mode if the speed is at or between Mach 1.85 and Mach 2.

It is contemplated to be within the scope of this invention that the hyperjet 100 described herein is not limited to use on aircraft, but could also be used in other type of crafts and vehicles, such as, but not limited to speedboats.

The following illustrates the mathematical model of the operation of hyperjet 100:

It is noted that only metric units of measure are being used.

Nomenclature:

Symbol Meaning

f Stoichiometric fuel-to-air mass ratio.
Tₐ Actual ambient temperature.
T₀ₐ Tea Total (stagnation) ambient temperature.
T₀₄ Maximum (stagnation) temperature generated by combustion.
Q_{R} Fuel heating value; average 45 MJ/kg for fuel “JP4”.
cₚ Specific heat of air at constant pressure; 1003.5 J/(kg*K)
cᵥ Specific heat of air at constant volume; 716.8 J/(kg*K)
R Perfect gas constant; 287 J/(kg*K)
H_{R} Specific heat ratio of air; 1.4 ambient; 1.36 within (and ideal case for) nozzle.
M Flight Mach (matches speed of aircraft).
Mₑ Exhaust Mach upon leaving the nozzle.
v Speed of aircraft (flight speed/airspeed).
Vₑ Exhaust speed upon leaving the nozzle.
Aₑ Cross-sectional area of the end of the supersonic nozzle.
Tₑ Exhaust temperature upon leaving the nozzle.
pₐ Ambient pressure (1 atmosphere at given altitude).
pₑ Exhaust pressure upon leaving the nozzle.
p₀₆ Maximum (stagnation) pressure generated by combustion.
p₀ₐ Total (stagnation) pressure before combustion.
ma Mass flow rate of air only (in ramjet mode), and of exhaust only (in pulsejet mode).
F/mₐ Specific thrust. Special unit of measure: “(newton of thrust) per (kilogram per second of exhaust gas)”.
TSFC Specific fuel consumption. Special unit of measure: “(kilogram per second of fuel) per (newton of thrust)”.

Formulas Used in Calculations

1. Regarding fuel-to-air ratio and exhaust temperature:

Assumptions:

1. Within ramjet combustion, total pressure changes only once;
2. Pulsejet combustion occurs in a constant volume.
   Formula for Ramjet Mode:
   f=((T₀₄/T₀ₐ)−1)/((Q_{R}/(cₚ*T₀ₐ))−(T₀₄/T₀ₐ))
   Formula for Pulsejet Mode:
   f=((T₀₄/T₀ₐ)−1)/((Q_{R}/(cᵥ*T₀ₐ))−(T₀₄/T₀ₐ))
2. Regarding Exhaust Mach:
   Mₑ²=(2/(H_{R}−1))*((1+((H_{R}−1)/2)*M²)*(((p₀₆/p₀ₐ)*(pₐ/pₑ))^{(H}_{R}^{-1)/H}_{R}−1))
3. Regarding Exhaust Speed:
   vₑ=Mₑ*((H_{R}*R*T₀₄)/(1+(Me²*((H_{R}−1)/2))))^{0.5}
4. Regarding Specific Thrust:
   Gross (Ignoring Speed of Aircraft):
   F/mₐ=(vₑ*(1+f))+(Aₑ*(pₑ−pₐ)/mₐ)
   Net (Accounting for Speed of Aircraft):
   F/mₐ=(vₑ*(1+f))−v+(Aₑ*(pₑ−pₐ)/mₐ)
5. regarding specific fuel consumption:
   TSFC=f/(F/mₐ)
   Pulsejet Mode Behavior at Take-off:
Environment: Tₐ=290 K, pₐ=101325 Pₐ, T₀₄=2000 K, air density=1.225 kg/m³.
Before first pulse: p₀₂=pₐ, T₀₂=Tₐ (no speed yet).
On first pulse:
Combustion (from formula 1): f=0.028
Assuming perfect gas behavior: (p₀₆/p₀ₐ)=(T₀₆/T₀ₐ), so p₀₆=698793.1 Pa
To avoid shock formation at exhaust, exhaust pressure must (ideal case) equal ambient pressure, so:
Exhaust Mach (from formula 2): Mₑ=1.9253
Exhaust speed (from formula 3): vₑ=1317.43 m/s
Gross specific thrust (from formula 4): F/mₐ=1354.32 N/(kg/s)
Specific fuel consumption (from formula 5): TSFC=2.067*10⁻⁵ (kg/s)/N
Comparison: Typical turbojet TSFC at take-off is 7*10⁻⁵ (kg/s)/N and typical high bypass turbofan TSFC at take-off is 1.5*10⁻⁵ (kg/s)/N.
Estimating main burner dimensions for 1 MN (same as 224719 LBS) thrust at 200 pulses/second at take-off:
Exhaust mₐ=Thrust/(F/mₐ₎=738.38 kg/s, therefore 3.69 kg of exhaust are required from each pulse.
   Only the air which is initially enclosed in the main burner at environment air density is exhausted in each pulse, so the main burner required volume is 3.013 m³; if choosing a main burner length of 2 m, then the internal cross-sectional area is 1.5065 m², so the main burner internal radius is 0.7 m.
   Pulsejet Mode Behavior at Mach 2:
Environment (from Reference 1, appendix III):
Altitude=10 km (given), v=599.064 m/s (derived),
Tₐ=223.252 K, pₐ=26500 Pa, T₀₄=2000 K, air density=0.41351 kg/m³.
   Before the air enters main burner (from Reference 2, table A2):
p₀ₐ=207355.2426 Pa
   Due to a slight-vacuum effect created by each pulse plus airflow buildup on the front flow gate (when closed), the maximum possible pressure before combustion is 2* p₀ₐ=414710.4852 Pa, but total temperature stays constant (401.85 K).
Combustion from formula 1): f=3.154*10⁻⁴
Assuming perfect gas behavior: (p₀₆/P₀ₐ)=(T₀₆/T₀ₐ), so p₀₆=2064006.39 Pa
   To avoid shock formation at exhaust, exhaust pressure must (ideal case) equal ambient pressure, so:
Exhaust Mach (from formula 2): Mₑ=3.4642
Exhaust speed (from formula 3): vₑ=1721.775 m/s
Net specific thrust from formula 4): F/mₐ=1123.25405 N/(kg/s)
Specific fuel consumption from formula 5): TSFC=2.808*10⁻⁷ (kg/s)/N
Comparison: The most efficient turbofans to date, used on aircraft Boeing 777™, have a TSFC of 10⁻⁶ (kg/s)/N.
   Ramjet Mode Behavior at Mach 2:
Environment: Altitude=10 km (given), v=599.064 m/s (derived), Tₐ=223.252 K,
pₐ=26500 Pₐ,
T₀₄=2500 K, air density=0.41351 kg/m³.
   Within One Small Combustor:
Before air entry:
p₀ₐ=207355.2426 Pa and T₀ₐ=401.85 K
Combustion (from formula 1): f=0.04955
Assuming perfect gas behavior: (p₀₆/p₀ₐ)=(T₀₆/T₀₀ₐ), SO p₀₆=2064006.39 Pa
   To ensure that the air coming into the main burner does not change direction and/or speed upon mixing with the exhaust from the small combustors (herein described as the ramjet burners 116), the exhaust speed from the small combustors must equal the speed of the main burner airflow:
v_{e(combustor)}=599.064 m/s. This leaves a lot of high pressure and temperature (from the small combustors' exhaust) to mix with (thus increasing the overall pressure and temperature of) the airflow in the main burner, so:
Exhaust Mach (from formula 2): M_{e(combustor)}=0.6276
Exhaust pressure (from Reference 2, table A2): p_{e(combustor)}=1582881.547 Pa
Exhaust temperature (from Reference 2, table A2): T_{e(combustor)}=2317.44 K
   Within Main Burner Combustion Occurs in Small Combustors Only):
Assumption: Total projected area of all small combustors is 20% of main burner cross-sectional area, therefore airflow behavior resembles that of a “turbofan with bypass ratio of 4 and mixed airflows”, so:
Mean pressure (not stagnation) in main burner becomes 337776.31 Pa
Mean temperature (not stagnation) in main burner becomes 642.09 K
Speed of sound in main burner from formula 3) is 507.93 m/s and Mach of mixed airflow is 1.1794 upon completing the mixing process, so from Reference 2, table A2: p₀₍ₑₓᵢₜ₎=798090.605 Pa and T₀₍ₑₓᵢₜ₎=820.9 K. Now exit pressure must match ambient pressure, so p(exit)/p0(exit)=0.332, so:
Exhaust Mach (from formula 2): Mₑ=1.365
Exhaust temperature (from Reference 2, table A2): Tₑ=598.04207 K
Exhaust speed (from formula 3): vₑ=659.5 m/s
Net specific thrust (from formula 4): F/mₐ=665.5307 N/(kg/s)
Specific fuel consumption ( from formula 5): TSFC=1.489*10⁻⁵ (kg/s)/N
Given the previously estimated dimensions, thrust in ramjet mode at Mach 2 is 248368 N (same as 55813 LBS).
Comparison: At Mach 2 flight speed, existing ramjets have an average TSFC of 6*10⁻⁵ (kg/s)/N and turbojets have an average TSFC of 3.5*10⁻⁵ (kg/s)/N.
   Ramjet Mode Behavior at Mach 6:
Environment: Altitude=10 km (given), v=1797.192 m/s (derived),
Tₐ=223.252 K, pₐ=26500 Pₐ,
T₀₄=2500 K, air density=0.41351 kg/m³.
   Within One Small Combustor:
Before air entry (from Reference 2, table A2):
p₀ₐ=4184139 Pa and T₀ₐ=1912.685 K
Combustion (from formula 1): f=0.01387
Assuming perfect gas behavior: (p₀₆/p₀ₐ)=(T₀₆/T₀ₐ), so p₀₆=54719071.62 Pa
   To ensure that the air coming into the main burner does not change direction and/or speed upon mixing with the exhaust from the small combustors, the exhaust speed from the small combustors must equal the speed of the main burner airflow:
V_{e(combustor)}=1797.192 m/s. This leaves a lot of high pressure and temperature (from the small combustors' exhaust) to mix with (thus increasing the overall pressure and temperature of) the airflow in the main burner, so:
Exhaust Mach (from formula 2): M_{e(combustor)}=2.86
Exhaust pressure (from Reference 2, table A2): p_{e(combustor)}=18402023.8 Pa
Exhaust temperature (from Reference 2, table A2): T_{e(combustor)}=948.425 K
   Within Main Burner (Combustion Occurs in Small Combustors Only):
Assumption: Total projected area of all small combustors is 20% of main burner cross-sectional area, therefore airflow behavior resembles that of a “turbofan with bypass ratio of 4 and mixed airflows”, so:
Mean pressure (not stagnation) in main burner becomes 3701604.76 Pa
Mean temperature (not stagnation) in main burner becomes 368.3 K
Speed of sound in main burner (from formula 3) is 379.15 m/s and Mach of mixed airflow is 4.74 upon completing the mixing process, so from Reference 2, table A2: p₀₍ₑₓᵢₜ₎=143473052.7 Pa and T₀₍ₑₓᵢₜ₎=2022.85 K. Now exit pressure must match ambient pressure, so p₍ₑₓᵢₜ₎/p₀₍ₑₓᵢₜ₎=1.847*10⁽⁻⁴⁾, so:
Exhaust Mach (from formula 2): Mₑ=7.4
Exhaust temperature (from Reference 2, table A2): Tₑ=1710.077 K
Exhaust speed (from formula 3): vₑ=6045.747 m/s
Net specific thrust (from formula 4): F/mₐ=6062.518 N/(kg/s)
Specific fuel consumption (from formula 5): TSFC=4.5756*10⁻⁷ (kg/s)/N
Given the previously estimated dimensions, thrust in ramjet mode at Mach 6 is 6787387.9 N (same as 1525255.7 LBS).
Comparison: At Mach 6 flight speed, existing ramjets have an average TSFC of 2.5*10^{31 5} (kg/s)/N.

The following two references were referred to in working out the above:
1. P. Hill, C. Peterson: Mechanics and Thermodynamics of Propulsion, 2nd edition Addison-Wesley Publishing Company, 1992 ISBN 0-201-146592
2. M. Saad: Compressible Fluid Flow Prentice Hall, Inc., 1985 ISBN 0-13-163486

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An aircraft engine, comprising:
a housing having an intake and an exhaust;
a first airflow gate disposed in said housing at said intake, said first airflow gate operable in at least a first position and a second position, said first airflow gate permitting air to flow within said housing when is said first position, and said first airflow gate preventing air from flowing within said housing when in said second position; and
a plurality of ramjet burners disposed in said housing proximate said first airflow gate.

2. The aircraft engine as recited in claim 1, and further including a second airflow gate disposed in said housing at said exhaust, said second airflow gate operable in at least a first position and a second position, said second airflow gate permitting gas to flow out of said housing when is said first position, and said second airflow gate preventing gas from flowing out of housing when in said second position

3. The aircraft engine as recited in claim 1, wherein said plurality of ramjet burners being configured in a ring in said housing.

4. The aircraft engine as recited in claim 2, and further including a main burner positioned within said housing.

5. The aircraft engine as recited in claim 4, the aircraft engine being operable in a pulsejet mode, such that said main burner, first airflow gate and said second airflow gate cycle through the following steps;
said first airflow gate and said second airflow gate each being in said second position enclosing air in said main burner;
spraying and detonating fuel in said main burner;
changing said second airflow gate from said second position to said first position permitting gas to exit said housing;
changing said first airflow gate from said second position to said first position permitting gas to enter into said housing;
changing said second airflow gate from said first position to said second position; and
changing said first airflow gate from said first position to said second position.

6. The aircraft engine as recited in claim 3, the aircraft engine being operable in a ramjet mode, such that each of said first airflow gate and said second airflow gate are each in said first positions, and at least two of said plurality of ramjet burners are operating simultaneously.

7. The aircraft engine as recited in claim 6, wherein said at least two of said plurality of ramjet burners operating are positioned opposite each other within said housing.

8. The aircraft engine as recited in claim 3, the aircraft engine being operable in a chemical rocket mode, such that said first airflow gate is in said second position and said second airflow gate is in said first position.

9. An aircraft engine, comprising:
a housing having an intake and an exhaust;
a first airflow gate disposed in said housing at said intake, said first airflow gate operable in at least a first position and a second position, said first airflow gate permitting air to flow within said housing when is said first position, and said first airflow gate preventing air from flowing within said housing when in said second position;
a main burner disposed within said housing; and
a plurality of ramjet burners disposed in said housing proximate said first airflow gate.

10. The aircraft engine as recited in claim 9, and further including a second airflow gate disposed in said housing at said exhaust, said second airflow gate operable in at least a first position and a second position, said second airflow gate permitting gas to flow out of said housing when is said first position, and said second airflow gate preventing gas from flowing out of housing when in said second position.

11. The aircraft engine as recited in claim 10, wherein said plurality of ramjet burners being configured in a ring in said housing.

12. The aircraft engine as recited in claim 11, the aircraft engine being operable in a pulsejet mode, such that said main burner, first airflow gate and said second airflow gate cycle through the following steps;
said first airflow gate and said second airflow gate each being in said second position enclosing air in said main burner;
spraying and detonating fuel in said main burner;
changing said second airflow gate from said second position to said first position permitting gas to exit said housing;
changing said first airflow gate from said second position to said first position permitting gas to enter into said housing;
changing said second airflow gate from said first position to said second position; and
changing said first airflow gate from said first position to said second position.

13. The aircraft engine as recited in claim 12, the aircraft engine being operable in a ramjet mode, such that each of said first airflow gate and said second airflow gate are each in said first positions, and at least two of said plurality of ramjet burners are operating simultaneously.

14. The aircraft engine as recited in claim 13, wherein said at least two of said plurality of ramjet burners operating are position opposite each other within said housing.

15. The aircraft engine as recited in claim 14, the aircraft engine being operable in a chemical rocket mode, such that said first airflow gate is in said second position and said second airflow gate is in said first position.

16. An aircraft engine operable in one of at least a pulsejet mode, a ramjet mode, and a chemical rocket mode, comprising:
a housing having an intake and an exhaust;
a first airflow gate disposed in said housing at said intake, said first airflow gate operable in at least a first position and a second position, said first airflow gate permitting air to flow within said housing when is said first position, and said first airflow gate preventing air from flowing within said housing when in said second position;
a second airflow gate disposed in said housing at said exhaust, said second airflow gate operable in at least a first position and a second position, said second airflow gate permitting gas to flow out of said housing when is said first position, and said second airflow gate preventing gas from flowing out of housing when in said second position
a main burner disposed within said housing; and
a plurality of ramjet burners disposed in said housing proximate said first airflow gate.

17. The aircraft engine as recited in claim 16, wherein said plurality of ramjet burners being configured in a ring in said housing.

18. The aircraft engine as recited in claim 17, such that when said aircraft engine is being operated in the pulsejet mode, said main burner, first airflow gate and said second airflow gate cycle through the following steps;
said first airflow gate and said second airflow gate each being in said second position enclosing air in said main burner;
spraying and detonating fuel in said main burner;
changing said second airflow gate from said second position to said first position permitting gas to exit said housing;
changing said first airflow gate from said second position to said first position permitting gas to enter into said housing;
changing said second airflow gate from said first position to said second position; and
changing said first airflow gate from said first position to said second position.

19. The aircraft engine as recited in claim 18, such that when said aircraft engine is being operated in the ramjet mode, each of said first airflow gate and said second airflow gate are each in said first positions, and at least two of said plurality of ramjet burners are operating simultaneously.

20. The aircraft engine as recited in claim 14, such that when said aircraft engine is being operated in the chemical rocket mode, said first airflow gate is in said second position and said second airflow gate is in said first position.
